(19) United States
(12) Patent Application Publication
(10) Pub. No.: US 2009/0315897 A1
(43) Pub. Date: Dec. 24, 2009

(54) ANIMATION PLATFORM

(75) Inventors: Paul Kwiatkowski, Bellevue, WA (US); Sankhyayan Debnath, Seattle, WA (US); Jay Edward Turney, Seattle, WA (US); Martyn Simon Lovell, Seattle, WA (US); Billie Sue Chafins, Seattle, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/145,494

(22) Filed: Jun. 24, 2008

(51) Int. Cl. G06T 15/70

(52) U.S. Cl. 345/473

(57) ABSTRACT

An animation platform for managing the interpolation of values of one or more animation variables from one or more applications. The animation platform uses animation transitions to interpolate the values of the animation variables. The animation platform uses a continuity parameter to smoothly switch from one animation transition to the next.

### BACKGROUND

Computer applications use variables for a variety of different tasks. In the past, each application maintained full responsibility for changing the values of its variables. Individually managing each and every variable can become difficult in an interactive computing system. In such a system, each individual application is responsible for resolving conflicting instructions to assign values to a variable, and each individual application is responsible for ensuring that variable values are changed in an acceptable manner. Such responsibilities can become burdensome when the application receives conflicting instructions from a user, another application, and/or the operating system.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

An animation platform is provided for managing the interpolation of values of one or more animation variables from one or more applications. The animation platform uses animation transitions to interpolate the values of the animation variables. The animation platform uses a continuity parameter to smoothly switch from one animation transition to the next.

### BRIEF DESCRIPTION OF THE DRAWINGS

FIG. 1 shows an example computing system configured to run an animation platform in accordance with an embodiment of the present disclosure.

FIG. 2 is a process flow of a method for an animation platform to manage animation scheduling and execution for one or more applications.

FIG. 3 somewhat schematically shows an animation platform using two different animation transitions to interpolate values of an animation variable.

FIG. 4 somewhat schematically shows an animation platform compressing a first animation transition before initiating a second animation transition.

FIG. 5 somewhat schematically shows an animation platform trimming a first animation transition before initiating a second animation transition.

FIG. 6 somewhat schematically shows an animation platform cancelling a first animation transition before initiating a second animation transition.

FIG. 7 somewhat schematically shows an animation platform concluding a cyclic animation transition before initiating a subsequent animation transition.

FIG. 8 is a process flow of a method for managing an animation variable so as to smoothly switch from one animation transition to the next.

FIG. 9 somewhat schematically shows an animation platform using a continuity parameter to smoothly switch from a first animation transition to a second animation transition.

FIG. 10 is a process flow of another method for managing an animation variable so as to smoothly switch from one animation transition to the next.

### DETAILED DESCRIPTION

An animation platform is disclosed. The animation platform can be used to manage animation scheduling and/or execution for one or more applications. As described in more detail below, the animation platform can alter the value of selected animation variables in an application over time. Such animation variables can be used for virtually any purpose by the application. Although described below in the context of animation variables that affect the visual appearance of a graphical object on a display, it should be understood that the present disclosure is equally applicable to varying animation variable values for other purposes, such as adjusting an audio characteristic, among others.

The animation platform can simplify the animation responsibilities of a variety of different applications by centralizing the updating of animation variables to the animation platform. In an interactive system in which user events may trigger complex animations involving many variables, it can become a burden for each individual application to track various animations. Furthermore, several applications may desire to adjust one or more variables in the same manner as other applications. A common animation platform that can serve two or more different applications may ease application development, enrich application capabilities, and/or provide consistency across multiple applications. Furthermore, the animation platform can be extensible, so as to be adaptable as the needs of applications change.

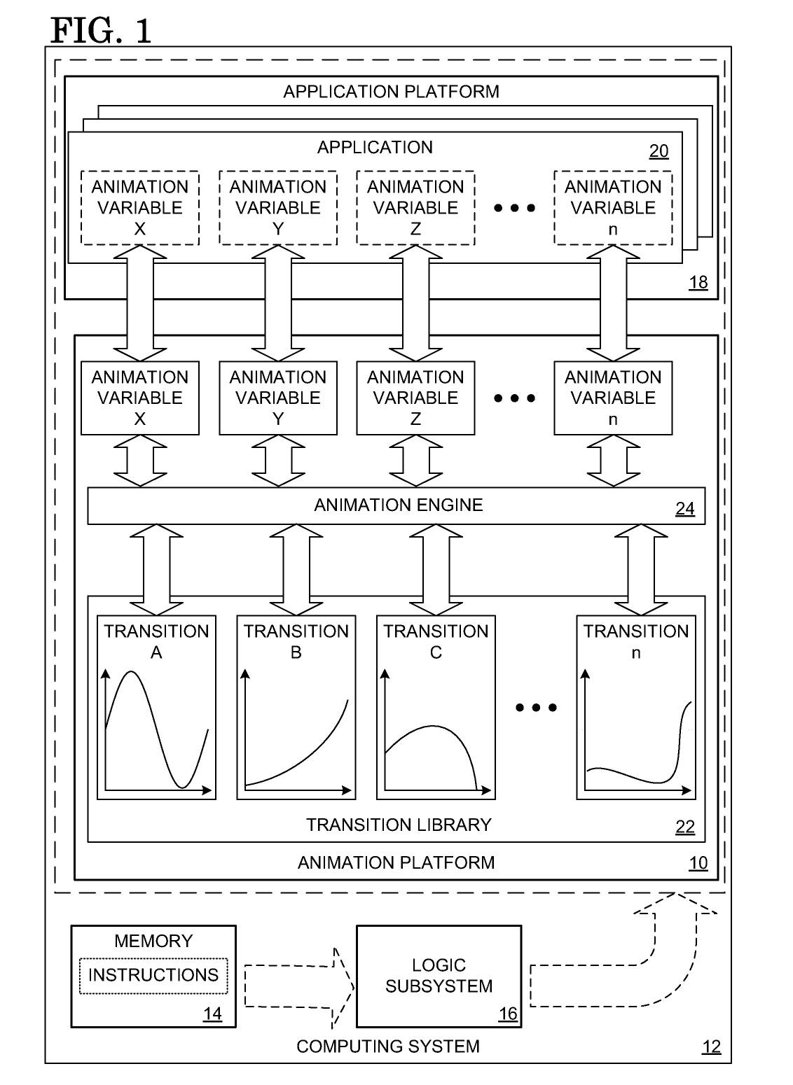

FIG. 1 schematically shows a nonlimiting example embodiment of an animation platform 10. In particular, FIG. 1 schematically shows a computing system 12 that includes memory 14 and logic subsystem 16 for running animation platform 10.

Logic subsystem 16 may be configured to execute one or more instructions, including instructions responsible for providing the herein described animation platform functionality. For example, the logic subsystem may be configured to execute one or more instructions that are part of one or more programs, routines, objects, components, data structures, or other logical constructs. Such instructions may be implemented to perform a task, implement an abstract data type, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments.

Memory 14 may include one or more devices configured to hold instructions that, when executed by the logic subsystem, cause the logic subsystem to implement the herein described methods and processes. Memory 14 may include volatile portions and/or nonvolatile portions. In some embodiments, memory 14 may include two or more different devices that may cooperate with one another to hold instructions for execution by the logic subsystem. In some embodiments, logic subsystem 16 and memory 14 may be integrated into one or more common devices and/or computing systems.

As schematically shown in FIG. 1, the logic subsystem and the memory may cooperate to establish an application platform 18 for running one or more applications, such as application 20. Such applications may include third-party client applications, system applications, portions of an operating system, and the like.

Animation platform 10 allows each application to utilize one or more animation variables of the animation platform, and such animation variables can be updated by an animation engine 24 of the animation platform 10. FIG. 1 shows animation variable X, animation variable Y, animation variable Z, and animation variable n as examples. An application can use an animation variable for any number of different purposes, including, but not limited to, as a positional parameter (e.g., x or y coordinate, height, width, etc.), as an audio parameter (e.g., frequency, tone, volume, playback speed, etc.), or as a color parameter (e.g., hue, chroma, lightness, etc.). The above are nonlimiting examples, and it is to be understood that an application may use an animation variable for virtually limitless different purposes. Other example uses include rotation, size, transparency, brightness, saturation, thickness, length, height, width, and font size/weight, among others.

Animation platform 10 may have access to a plurality of animation transitions. As an example, FIG. 1 shows a transition library 22 that includes animation transition A, animation transition B, animation transition C, and animation transition n. Each of the individual animation transitions may be applied to an animation variable via an animation engine 24. In some embodiments, the animation engine may be incorporated into the animation transitions.

Each animation transition can be configured to interpolate animation variable values as a function of time (or another suitable input). As nonlimiting examples, an animation variable may be the y coordinate position of an object on a display. A first animation transition may cause the value of the animation variable (e.g., y coordinate, where y=0 at top of display, and y=1050 at bottom of display) to decrease at a continually accelerating rate, thus simulating a rocket ship. A second animation transition may simulate an object thrown into the air and pulled back to the ground by gravity. A third animation transition may simulate a bouncing ball, a fourth animation transition may mimic a sine wave, and so on. Furthermore, while each of the above described example animation transitions could be used to interpolate a y coordinate value, the same animation transitions may be used to interpolate the frequency of a sound, the hue of a color, or any number of other adjustable parameters.

Animation transitions can be configured to adjust the values of animation variables to produce any number of different desired results. As a nonlimiting example, an animation transition can be configured to make a pull-down menu of an application user interface appear to accelerate when beginning to open and decelerate when concluding to open. To cause such a result, the application may have a variable used to set the openness of the pull-down menu, and the application can employ the animation platform to apply an animation transition that interpolates values of the openness variable to achieve the desired effect (e.g., by using a cosine function to interpolate the values).

In some embodiments, the animation platform may be configured to extensibly incorporate one or more plug-in animation transitions configured to interpolate animation variable values. As such, capabilities of the animation platform can be extended by adding new extensible plug-in animation transitions or improving existing animation transitions. In some embodiments, the animation platform may include one or more built-in animation transitions that are not extensible plug-ins.

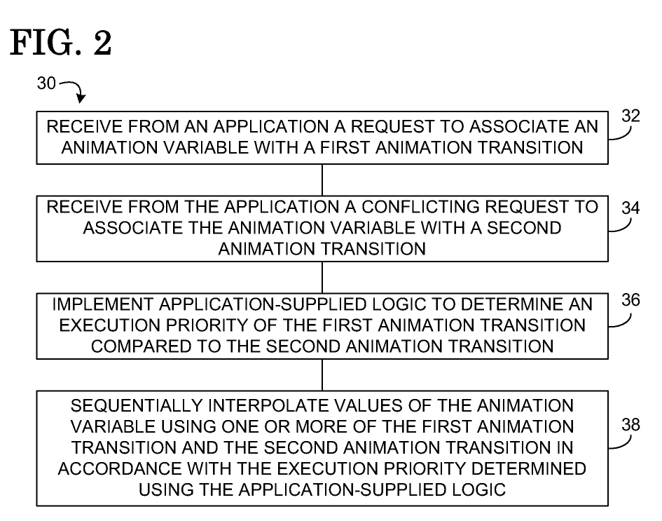

FIG. 2 shows a process flow of an example method 30 for an animation platform to manage animation scheduling and execution for one or more applications. At 32, method 30 includes receiving from an application a request to associate an animation variable with a first animation transition. In other words, the animation platform can receive a request to take over interpolation responsibilities for the animation variable, thus freeing the application of that task. Such a request may be received via an application programming interface (API) or via another suitable channel. The request can be an individual request to associate a single animation variable with a single animation transition, or the request may be part of a storyboard request in which one or more animation variables are associated with one or more animation transitions. In other words, two or more animation transitions can be constituent elements of a storyboard, and each individual animation transition of the storyboard can be used to interpolate values of an associated animation variable in the order specified by the storyboard and/or with specific time offsets relative to one another.

An animation transition may be configured to receive one or more input parameters, which may affect the values interpolated by the animation transition. For example, an animation transition may receive as an input parameter a pass value of an animation value as interpolated by a previously executed animation transition. In other words, a second animation transition may use the pass value from a first animation transition to pick up where the first animation transition left off. As another example of an input parameter, a newly executed animation transition may receive the time-rate-of-change at which the values of the animation variable had been changing before execution of the new animation transition. As described in more detail below, by using the time-rate-of-change of the values of an animation variable, the animation platform can smoothly switch from one animation transition to another animation transition in a coordinated manner.

The animation platform may receive a range of acceptable start times for a particular animation transition. In other words, an application may specify that the animation transition is to begin within a predetermined time period (e.g., 500 milliseconds). In some embodiments, the earliest and latest acceptable start times may be independently specified (e.g., earliest=immediately; latest=before specified finite delay). As described in more detail below, such start times can be used when determining how to handle conflicting requests to apply different animation transitions to the same animation variable and/or when determining how to handle if another event conflicts with a previously requested animation transition.

At 34, method 30 includes receiving from the application a conflicting request to associate the animation variable with a second animation transition (e.g., a repeat of the previously executed animation transition, a different animation transition, or a null animation transition). While this description focuses on scheduling conflicts between individual animation transitions, it should be understood that such individual animation transitions can be part of a larger storyboard.

A conflicting request may result from any number of different scenarios. For example, in response to a first user input an application may request the animation platform to associate an animation variable with a first animation transition; and then in response to a second conflicting user input the application may request the animation platform to associate the same animation variable with a second animation transition.

It should be understood that a conflicting request to associate an animation variable with a different animation transition can occur even if the application does not make a specific request to make subsequent changes to the particular animation variable. As an example, a subsequently requested storyboard may conflict with an animation transition in a previously requested storyboard, although the subsequent storyboard does not specifically request any changes be made to the animation variable. In such a case, a request to change values of an animation variable using a first animation transition can be subsequently cancelled via associating the animation variable with a null animation transition (i.e., an animation transition that makes no changes to the animation variable). For purposes of this disclosure, an animation variable is considered to be associated with a null animation transition when there is not another animation transition making changes to values of the animation variable. In practice, an animation variable can be associated with a null transition by taking no action if the animation value was not previously associated with another animation transition, or by cancelling another animation transition to which the animation variable was previously associated.

At 36, method 30 includes implementing application-supplied logic to determine an execution priority of the first animation transition compared to the second animation transition. As described in more detail below, application supplied-logic can be implemented in a variety of different manners. In some cases, an application can supply its prioritization logic in advance of actual conflicting requests, and the animation platform can implement the supplied logic as prioritization decisions arise. In other cases, the animation platform can communicate with the application as conflicts arise, thus giving the application the ability to make prioritization decisions on the fly.

For example, when an application requests the animation platform to schedule a storyboard (including one or more animation transitions), the animation platform can determine if any conflicts exist. In other words, the animation platform can determine whether and when the storyboard can be executed. The application provides the animation platform with information to help identify any conflicts, such as the earliest and latest acceptable start times to begin the requested animation transitions. In most scenarios, the animation platform will only allow a particular animation variable to be modified by one animation transition at a time, although such restrictions are not always enforced. For example, one or more animation transitions (or storyboards) can be specified as “relative,” in which case that animation transition can run concurrently with one or more other animation transitions so that the influences of the collective animation transitions are summed together.

Given the herein described constraints and policies (e.g., schedule requested animation transitions as early as possible), the animation platform attempts to schedule all newly requested animation transitions (or storyboards). If there are no conflicts, the animation platform can begin at the earliest acceptable time as specified by the application. If conflicts exist, the animation platform can implement application-supplied logic to resolve the conflicts.

In some embodiments, application-supplied logic can be implemented using one or more prioritization callbacks that allow the application to specify an execution priority of the animation transitions. An application can register one or more callback functions, which the animation platform can use to ask the application how conflicting animation transitions should be prioritized. When more than one callback function is used, each different callback function can be used to ask a different prioritization question.

The following callback functions are provided as examples which can be used to implement application-supplied logic (i.e., ask different prioritization questions). It should be understood that alternative and/or additional callback functions can be used, or the functionality of two or more callback functions can be implemented as a single callback function.

A CanCancel callback function is a first example of a prioritization callback function that can be used to implement application-supplied logic for making prioritization determinations. If a conflicting animation transition is scheduled to begin and will conflict with another animation transition, the first animation transition may be “cancelled” before it is executed, and the subsequent animation transition can take control of the contested animation variables. As used herein, cancelling an animation transition means stopping it before it begins (i.e., interpolates any animation values). Cancelling an animation transition may be desirable in many user interface scenarios, such as when a delayed visual response need no longer be shown because it has been superseded by a subsequent user action. The animation platform can use the CanCancel callback function to ask an application if a particular animation transition can be cancelled by another animation transition (or other event).

A CanTrim callback function is a second example of a prioritization callback function that can be used to implement application-supplied logic for making prioritization determinations. If a conflicting animation transition has begun or is scheduled to begin and will conflict with another animation transition, the first animation transition may be “trimmed,” and the subsequent animation transition can assume control of the contested animation variables. As used herein, trimming an animation transition means stopping it before it reaches its natural conclusion (i.e., interpolates all animation values). The animation platform can use the CanTrim callback function to ask an application if a particular animation transition can be trimmed by another animation transition (or other event).

A CanCompress callback function is a third example of a prioritization callback function that can be used to implement application-supplied logic for making prioritization determinations. If a conflicting animation transition has begun or is scheduled to begin and will conflict with another animation transition, the first animation transition may be “compressed,” and the subsequent animation transition can assume control of the contested animation variables. The animation platform can use the CanCompress callback function to ask an application if a particular animation transition can be compressed by another animation transition (or other event).

As used herein, compressing an animation transition means speeding it up to reach its natural conclusion at an accelerated rate. In some embodiments, the animation platform can implement the compression by feeding the compressed animation transition time information at an accelerated rate (e.g., speeding a clock input to the animation transition). For example, if a particular animation transition normally is set to execute for a duration of 500 milliseconds, the animation transition may periodically get time information from the animation platform and interpolate animation variable values based on such time information. If the animation transition is not compressed, the animation platform may supply unaltered time information to the animation transition. If the animation transition is compressed, the animation platform may determine when the compressed animation transition should end, and supply accelerated time information to the animation transition so that the compressed animation transition ends at the desired completion time and/or within a specified amount of time. In other words, an animation transition (or storyboard) continues to perform its arithmetic as if nothing changed, but the remainder of the system sees the progress of the compressed animation accelerated so that it concludes at an earlier time. It is worth noting that once an animation transition is compressed, it may be further compressed by a subsequent scheduling action.

A CanConclude callback function is a fourth example of a prioritization callback function that can be used to implement application-supplied logic for making prioritization determinations. If a conflicting animation transition has begun or is scheduled to begin and will conflict with a cyclic animation transition that does not have a specified end time, the cyclic animation transition may be “concluded” and the subsequent animation transition can assume control of the contested animation variables. As used herein, concluding a cyclic animation transition means exiting all current cycles and optionally executing a final set of interpolations. The animation platform can use the CanConclude callback function to ask an application if a particular cyclic animation transition can be concluded by another animation transition (or other event).

The circumstances under which cancelling, trimming, compressing, or concluding an animation transition is acceptable can be unique to each individual application, and can depend on the purpose of the animation transition(s) (or storyboard(s)) involved. The above described callback functions can be used by the animation platform to allow the application to decide how to resolve prioritization conflicts.

The animation platform can pass as parameters to a prioritization callback the first animation transition and the second animation transition, so that the application can use its logic to make a prioritization determination. The animation platform can also pass as a parameter to the prioritization callback an enumerated value specifying one or more consequences of the prioritization. An example consequence is whether a considered action (e.g., cancel, trim, compress, or conclude a first animation transition) is a condition for a subsequent animation transition to be executed in a suitable time range (e.g., as specified by the subsequent animation transition).

If no callback function is registered for a given comparison, a default function can be used to return the same answer for all conflicting requests. As an example, conflicting animation transitions may by default be cancelled, concluded, or compressed, but not trimmed. In general, application-supplied logic can be implemented to determine an execution priority when application-supplied logic is configured to resolve a prioritization comparison between conflicting animation transitions, and a default function can be implemented to determine an execution priority when application-supplied logic is not configured to resolve a prioritization comparison between conflicting animation transitions.

When the animation platform schedules a new storyboard including one or more animation transitions, the animation platform can follow a process that walks backwards through the currently scheduled storyboards, calling the different prioritization callback functions as appropriate. The start and end times of the various animation transitions may differ for different variables. Therefore, the animation platform is configured to detect conflicts at the level of individual animation transitions in addition to at the level of the larger storyboards.

As mentioned above, application-supplied logic can be implemented in a variety of different manners, including, but not limited to, using prioritization callback function. As another example, the animation platform may set the execution priority based on relative prioritizations supplied by the application. Such relative prioritizations may be supplied before any conflicts arise, or even before an application requests the animation variable to be associated with an animation transition. Relative prioritizations may include a set of “higher than” or “equal to” relationships between pairs of animation transitions. As a nonlimiting example, animation transition A could be given a higher priority than animation transition B, animation transition B could be given a higher priority than animation transition C, and animation transition C could be given a higher priority than animation transition A. If a conflict arises, an application-supplied logic similar to the above example can be used to determine how the conflict should be resolved. For example, if animation transition A conflicts with animation transition C, animation transition C could be prioritized over animation transition A because it has a higher priority than animation transition A.

As yet another example, the animation platform can set the execution priority based on numeric priority values supplied by the application. Such numeric priority values can be supplied before a conflict arises, or even before the application requests the animation variable to be associated with an animation transition. Numeric prioritizations may include an assigned rank to each animation transition. As a nonlimiting example, animation transition A could be ranked as a “1,” animation transition B could be ranked as a “3,” and animation transition C could be ranked as a “2.” If a conflict arises, an application-supplied logic similar to the above example can be used to determine how the conflict should be resolved. For example, if animation transition A conflicts with animation transition C, animation transition C could be prioritized over animation transition A because it has a higher ranking.

Method 30 of FIG. 2 also includes, at 38, sequentially interpolating values of the animation variable using one or more of the first animation transition and the second animation transition in accordance with the execution priority determined using the application-supplied logic. As specific examples, sequentially interpolating values of an animation variable in accordance with an execution priority determined using application-supplied logic includes: trimming a first animation transition and initiating a second animation transition; compressing a first animation transition and initiating a second animation transition; cancelling a first animation transition before the first animation transition begins and initiating a second animation transition; completing a first animation transition and initiating a second animation transition; and concluding cyclic execution of the first animation transition and initiating the second animation transition. In embodiments in which prioritization callback functions are used, an animation transition may be canceled, trimmed, compressed, or concluded in accordance with a response from the application to the prioritization callback function.

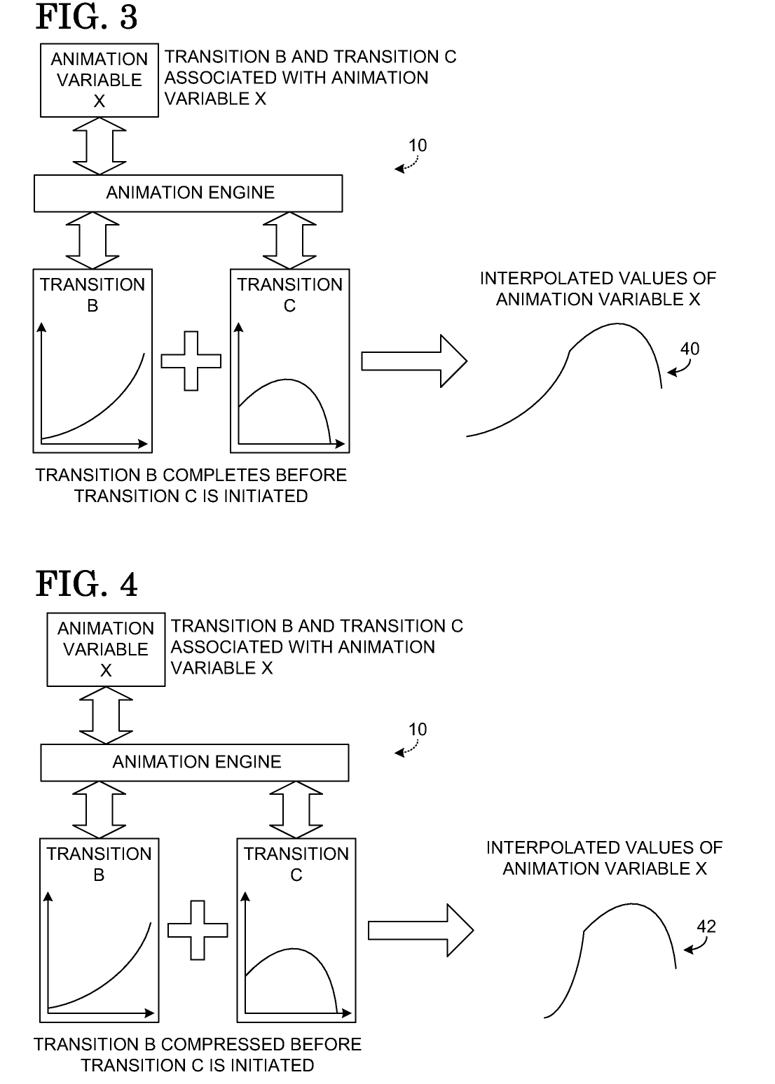

FIGS. 3-7 somewhat schematically show the effects cancelling, trimming, compressing, or concluding an animation transition has on the interpolated values of an animation variable. As a point of comparison, FIG. 3 schematically shows an animation transition B and an animation transition C. If animation transition B and animation transition C are both associated with an animation variable X, and animation transition C is scheduled to immediately follow animation transition B, the animation platform may interpolate values of animation variable X by first completing animation transition B and then initiating animation transition C where animation transition B left off. The resulting interpolated values are schematically shown at 40.

As shown in FIG. 4, if animation transition B and animation transition C are both associated with an animation variable X, and animation transition C is scheduled to immediately follow animation transition B, the animation platform may interpolate values of animation variable X by first compressing animation transition B and then initiating animation transition C where compressed animation transition B left off. The resulting interpolated values are schematically shown at 42.

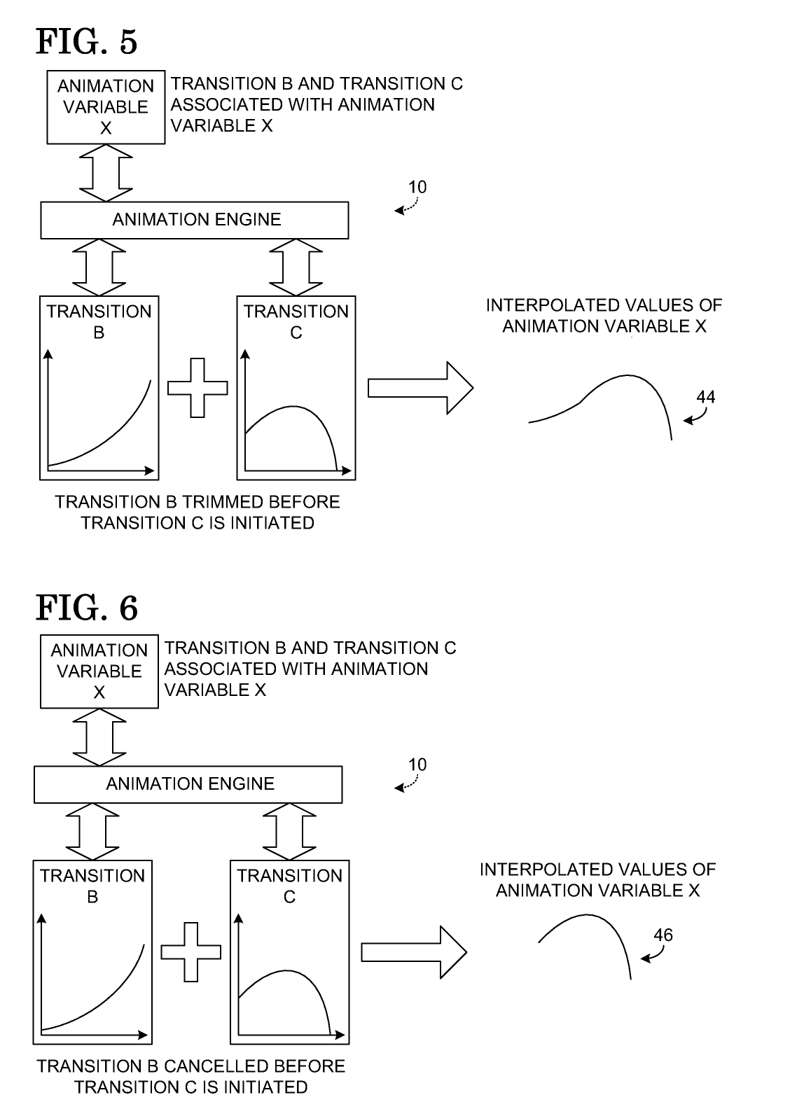

As shown in FIG. 5, if animation transition B and animation transition C are both associated with an animation variable X, and animation transition C is scheduled to immediately follow animation transition B, the animation platform may interpolate values of animation variable X by first trimming animation transition B and then initiating animation transition C where trimmed animation transition B left off. The resulting interpolated values are schematically shown at 44.

As shown in FIG. 6, if animation transition B and animation transition C are both associated with an animation variable X, and animation transition C is scheduled to immediately follow animation transition B, and if animation transition B has not yet initiated, the animation platform may interpolate values of animation variable X by cancelling animation transition B and initiating animation transition C without executing animation transition B. The resulting interpolated values are schematically shown at 46.

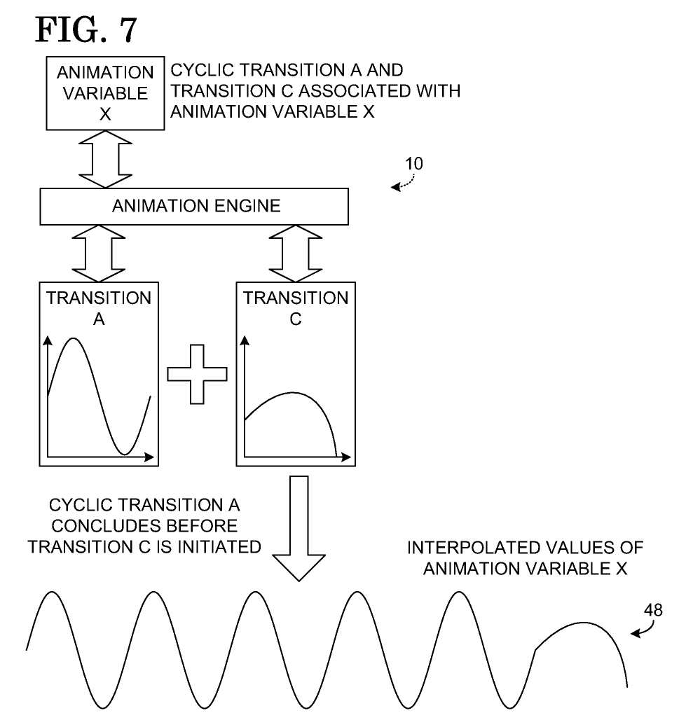

As shown in FIG. 7, if cyclic animation transition A and animation transition C are both associated with an animation variable X, and animation transition C is scheduled to immediately follow cyclic animation transition A, the animation platform may interpolate values of animation variable X by first concluding cyclic animation transition A and then initiating animation transition C where concluded cyclic animation transition A left off. The resulting interpolated values are schematically shown at 48.

As shown in FIGS. 3-5 and FIG. 7, switching from one animation transition to another animation transition may result in interpolated values that have sudden jumps in their time-rate-of-change. In other words, the interpolated values are not differentiable across all values. For many applications, it may be desirable for the animation platform to smoothly switch from one animation transition to the next. As a nonlimiting example, values of an animation variable that follow a smooth trajectory may provide pleasing visual effects when such variables are used to animate objects (e.g., user interface elements) on a display.

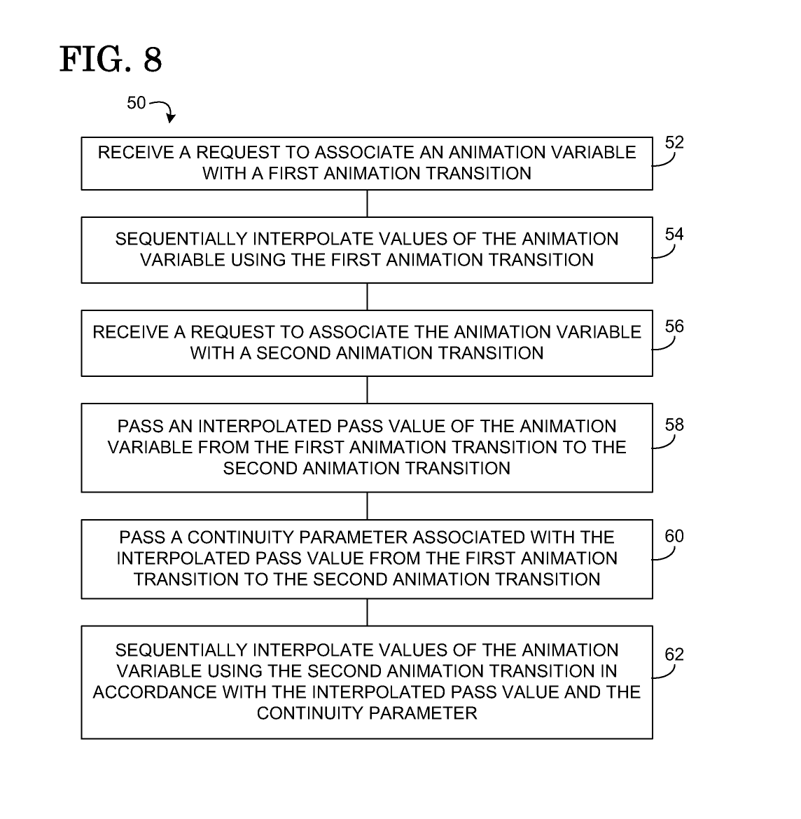

FIG. 8 shows a process flow of an example method 50 of managing an animation variable so as to smoothly switch from one animation transition to the next. At 52, method 50 includes receiving a request to associate an animation variable with a first animation transition. At 54, method 50 includes sequentially interpolating values of the animation variable using the first animation transition. At 56, method 50 includes receiving a request to associate the animation variable with a second animation transition. At 58, method 50 includes passing an interpolated pass value of the animation variable from the first animation transition to the second animation transition. At 60, method 50 includes passing a continuity parameter associated with the interpolated pass value from the first animation transition to the second animation transition. At 62, method 52 includes sequentially interpolating values of the animation variable using the second animation transition in accordance with the interpolated pass value and the continuity parameter.

The animation platform can utilize a continuity parameter so that, when desired, values of an animation variable can be smoothly interpolated from one animation transition to the next. In some embodiments, a continuity parameter may include a time-rate-of-change of animation variable values at an end of a period in which the first animation transition interpolates values of the animation variable.

For purposes of simplification, consider an animation transition that interpolates values according to the following function, where t equals time in milliseconds and pv equals the pass value from a previous animation transition:

f(t)=t³+pv

In this case, the time-rate-of-change of the values of the animation variable is given by the first derivative of the animation transition function, namely:

f′(t)=3t²

If the animation transition is passed a pass value equal to 10 and is set to run for 100 milliseconds, it will produce the following results (shown only at 5 millisecond intervals for simplicity):

| time | | |
|---|---|---|
| (milliseconds) | f (t) | f′ (t) |
| 0 | 10 | 0 |
| 5 | 135 | 75 |
| 10 | 1010 | 300 |
| 15 | 3385 | 675 |
| 20 | 8010 | 1200 |
| 25 | 15635 | 1875 |
| 30 | 27010 | 2700 |
| 35 | 42885 | 3675 |
| 40 | 64010 | 4800 |
| 45 | 91135 | 6075 |
| 50 | 125010 | 7500 |
| 55 | 166385 | 9075 |
| 60 | 216010 | 10800 |
| 65 | 274635 | 12675 |
| 70 | 343010 | 14700 |
| 75 | 421885 | 16875 |
| 80 | 512010 | 19200 |
| 85 | 614135 | 21675 |
| 90 | 729010 | 24300 |
| 95 | 857385 | 27075 |
| 100 | 1000010 | 30000 |

The value of the animation variable at time equals 100 milliseconds, 1000010, is an example of a pass value that can be passed to a subsequent animation transition. The first derivative, 30,000, is an example of a continuity parameter that can be passed to a subsequent animation transition.

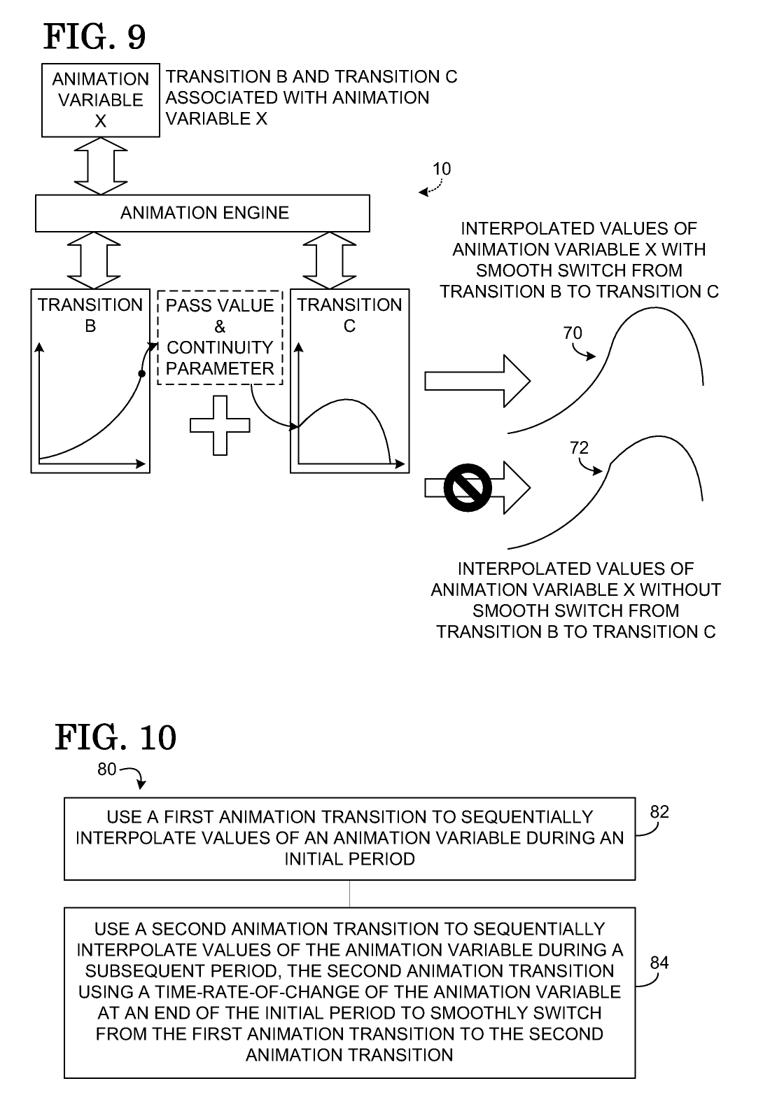

As demonstrated by example above, interpolated values of an animation variable over time may form a value-to-time function, and the continuity parameter may be a first derivative of the value-to-time function at a pass value. A subsequent animation transition can interpolate initial values of the animation variable so that the first derivative of the value-to-time function smoothly switches from the first animation transition to the second animation transition. Using the above scenario as an example, a subsequent animation transition may interpolate values so that a first derivative of the value-to-time function does not initially drastically deviate from the passed continuity parameter (i.e., 30,000). FIG. 9 schematically demonstrates this concept.

FIG. 9 schematically shows an animation transition B and an animation transition C applied to an animation variable X. The animation platform may interpolate values of animation variable X by first applying animation transition B and then applying animation transition C. Furthermore, the animation platform may use a continuity parameter to smoothly transition from one animation transition to the next. The continuity parameter may be a trajectory of final values of animation variable X as interpolated by animation transition B, for example. Either or both of animation transition B and animation transition A can be modified so that a time-rate-of-change of interpolated values of animation variable X will not vary drastically as animation transition C takes over interpolation responsibilities from animation transition B. For example, animation transition C may interpolate initial values of animation variable X so that the trajectory of initial values of animation variable X interpolated by animation transition C substantially matches the trajectory of final values of animation variable X interpolated by animation transition B.

The resulting smooth interpolated values are schematically shown at 70. As a point of comparison, the unsmoothed interpolated values are schematically shown at 72. It should be understood that in some scenarios, it may be desirable to have unsmoothed transitions.

FIG. 10 shows a process flow of another example method 80 of managing an animation variable so as to smoothly switch from one animation transition to the next. At 82, method 80 includes using a first animation transition to sequentially interpolate values of an animation variable during an initial period. At 84, method 80 includes using a second animation transition to sequentially interpolate values of the animation variable during a subsequent period, where the second animation transition uses a time-rate-of-change of the animation variable at an end of the initial period to smoothly switch from the first animation transition to the second animation transition. The time-rate-of-change of the values of the animation variable may be calculated as the first derivative of the animation transition function or approximated by interpolating values over a small time interval at an end of the initial period.

It will be appreciated that the embodiments described herein may be implemented, for example, via computer-executable instructions or code, such as programs, stored on computer-readable memory and executed by a computing device. Generally, programs include routines, objects, components, data structures, and the like that perform particular tasks or implement particular abstract data types. As used herein, the term “program” may connote a single program or multiple programs acting in concert, and may be used to denote applications, services, or any other type or class of program. Likewise, the terms “computer” and “computing device” as used herein include any device that electronically executes one or more programs, including two or more such devices acting in concert.

It should be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated may be performed in the sequence illustrated, in other sequences, in parallel, or in some cases omitted. Likewise, the order of the above-described processes may be changed.

The subject matter of the present disclosure includes all novel and nonobvious combinations and subcombinations of the various processes, systems and configurations, and other features, functions, acts, and/or properties disclosed herein, as well as any and all equivalents thereof.

1. A method of managing an animation variable, comprising:
receiving a request to associate the animation variable with a first animation transition;
sequentially interpolating values of the animation variable using the first animation transition;
receiving a request to associate the animation variable with a second animation transition;
passing an interpolated pass value of the animation variable from the first animation transition to the second animation transition;
passing a continuity parameter associated with the interpolated pass value from the first animation transition to the second animation transition; and
sequentially interpolating values of the animation variable using the second animation transition in accordance with the interpolated pass value and the continuity parameter.

2. The method of claim 1, where interpolated values of the animation variable over time form a value-to-time function, and where the continuity parameter is a first derivative of the value-to-time function at the pass value.

3. The method of claim 2, where the second animation transition interpolates initial values of the animation variable so that the first derivative of the value-to-time function smoothly switches from the first animation transition to the second animation transition.

4. The method of claim 1, where the continuity parameter is a trajectory of final values of the animation variable interpolated by the first animation transition.

5. The method of claim 4, where the second animation transition interpolates initial values of the animation variable so that the trajectory of initial values of the animation variable interpolated by the second animation transition substantially matches the trajectory of final values of the animation variable interpolated by the first animation transition.

6. The method of claim 1, where one or more of the first animation transition and the second animation transition is an extensible plug-in animation transition configured to interpolate animation variable values and a time-rate-of-change of animation variable values.

7. The method of claim 1, where receiving a request to associate the animation variable with an animation transition includes receiving the request via an application programming interface.

8. The method of claim 1, where the animation variable is a positional parameter.

9. The method of claim 1, where the animation variable is an audio parameter.

10. The method of claim 1, where the animation variable is a color parameter.

11. A method of managing an animation variable, comprising:
during an initial period, using a first animation transition to sequentially interpolate values of the animation variable; and
during a subsequent period, using a second animation transition to sequentially interpolate values of the animation variable, the second animation transition using a time-rate-of-change of the animation variable at an end of the initial period to smoothly switch from the first animation transition to the second animation transition.

12. The method of claim 11, where one or more of the first animation transition and the second animation transition are extensible plug-in animation transitions, each such extensible plug-in animation transition configured to interpolate animation variable values and a time-rate-of-change of animation variable values.

13. The method of claim 11, further comprising receiving a request to interpolate values of the animation variable via an application programming interface.

14. The method of claim 11, where the animation variable is a positional parameter.

15. The method of claim 11, where the animation variable is an audio parameter.

16. The method of claim 11, where the animation variable is a color parameter.

17. A computing system, comprising:
an application platform to run one or more applications, the application platform allowing each application to utilize an animation variable; and
an animation platform having access to a first animation transition and a second animation transition;
the animation platform using the first animation transition to sequentially interpolate values of the animation variable, including a pass value of the animation variable;
the animation platform passing from the first animation transition to the second animation transition the pass value of the animation variable and a continuity parameter associated with the pass value; and
the animation platform using the second animation transition to sequentially interpolate values of the animation variable in accordance with the pass value and the continuity parameter.

18. The computing system of claim 17, where the continuity parameter is a time-rate-of-change of animation variable values at an end of a period in which the first animation transition interpolates values of the animation variable.

19. The computing system of claim 17, where the animation platform is configured to extensibly incorporate one or more plug-in animation transitions configured to interpolate animation variable values and time-rate-of-change of animation variable values.

20. The computing system of claim 17, where the animation platform utilizes an application programming interface to receive requests to interpolate values of the animation variable.
